(19) United States
(12) Patent Application Publication
(10) Pub. No.: US 2010/0319173 A1
(43) Pub. Date: Dec. 23, 2010

(54) Apparatus for the connection of articles via at least one plasticizable connection element

(75) Inventors: Clemens Balle, Albstadt (DE); Thomas Baumeister, Aldingen (DE); Armin Beck, Denkingen (DE); Hartmut Jundt, Rottweil (DE); Bernd Prirsch, Villingendorf (DE); Joachim Wein, Deisslingen (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Maschinenfabrik Spaichingen GmbH, Spaichingen (DE)

(21) Appl. No.: 12/799,761

(22) Filed: Apr. 29, 2010

(30) Foreign Application Priority Data
May 6, 2009 (DE) 10 2009 020 173.4

(51) Int. Cl. B23P 11/00

(52) U.S. Cl. 29/243.54

(57) ABSTRACT

An apparatus for the connection of articles via at least one connection element plasticizable by heat includes a cap, in particular a heatable cap, which is movable toward and away from the connection element and which has a shaft, for the forming of a rivet head at the connection element and having means for the cooling of the cap by means of a cooling fluid, in particular air. A first variant is characterized in that the shaft of the cap has a central cooling fluid supply passage preferably reaching up to and into the cap body and a plurality of respective at least generally radially outwardly directed cooling fluid passages starting from the central cooling fluid supply passage are provided within the cap body. Provision can alternatively be made that the cap is manufactured at least partly from porous, air-permeable material, in particular ceramic material, and the shaft of the cap is provided with a cooling fluid supply bore preferably reaching up to and into the cap body. Means for the direct heating of the cap can in particular also be provided, with them advantageously including at least one ceramic heating element.

The invention relates to an apparatus for the connection of articles via at least one connection element plasticizable by heat, the apparatus having a cap, in particular a heatable cap, which is movable toward and away from the connection element and which has a shaft, for the forming of a rivet head at the connection element and having means for the cooling of the cap by means of a cooling fluid, in particular air.

Apparatus of this kind work according to the so-called rivet peg welding principle according to which a projection, the so-called rivet peg, formed at a connection element attached to one of the articles is pushed through an opening of the other article and is then provided with a shaped rivet head at the free end of the rivet peg. The connection element in this respect can also be made from a separate component which is pushed through both articles and has an already attached head at one end.

The shaping of the rivet head takes place, when the described welding principle is used, in that the rivet peg is plasticized by heating and is brought into the shape desired in the individual case by means of a tool called a cap in the following and pressed against the rivet peg. In this respect, at least one of the two joining partners is usually made from a plasticizable plastic, although it is also sufficient in principle, however, if only the involved connection elements or the rivet pegs provided thereon are made from a plasticizable material.

An apparatus of the initially named kind is described in DE 10 2004 057 453 B3. In this respect, a rivet cap is coupled to a heat source and is heated. As soon as the cap has reached a temperature which is above the softening point of the material to be processed, it is lowered onto the tool and reshapes a rivet peg into a rivet head. The rivet cap is subsequently decoupled from the heat source and cooled by having air blown on. The circumstance is thus taken into account that a heated cap cannot be removed from a rivet head immediately after the shaping of the respective rivet head, but that it is rather necessary to wait until the cap has cooled down to a temperature lying considerably below the melting point of the rivet peg material. There would otherwise be the risk that the rivet heads tear or the cap frays.

The cooling of the cap usually takes place by blowing air on from the side. The air sweeping past the cap can, however, only take up a little heat, which brings along the disadvantage that either blowing has to take place for a long time or a high air volume flow has to be used. A relatively high air consumption results in both cases.

An apparatus is described from DE 100 38 158 A1 having a form punch which is heatable for the forming of a respective rivet head and is surrounded by a flow boundary wall. Cooling air is introduced into the gap formed between the heatable form punch and the flow boundary wall for the subsequent cooling of the previously heated form punch. The cooling time is thus admittedly somewhat shortened or a reduction in the cooling air consumption is made possible, but an additional component effort results with the flow boundary wall, the respective fastening parts, etc. An apparatus is moreover described in this DE 100 38 158 A1 having a non-heatable form punch in which the plasticizable connection element is heated via a radiant heater and the form punch is provided with a gas supply passage which opens at the free end and via which the connection element is exposed to a gas flow directly before the deformation procedure, said gas flow being heated by the radiant heater to achieve a more homogeneous heating of the connection element. The gas volume can be increased during the deformation process with an end of the supply passage closed by the connection element, with the gas then escaping via a branch-off line directed, starting from the supply passage, generally obliquely upwardly at a substantial spacing from the contact surface to the connection element and away from said contact surface, whereby a certain cooling of the form punch and thus of the shaped rivet head is achieved. In particular in the case of a heatable cap, i.e. of a heating of the connection element primarily via the cap coming into contact therewith, a relatively long cooling time or a relatively high air consumptions would still result, however.

It is the underlying object of the invention to provide an improved apparatus of the initially named kind with which the aforesaid disadvantages have been eliminated. In this respect, in particular the cooling fluid consumption should be reduced or the cooling time further shortened with a minimal apparatus effort.

In accordance with a first alternative of the invention, this object is satisfied in that the shaft of the cap has a central cooling fluid supply passage which preferably reaches up to and into the cap body and a plurality of respective at least generally radially outwardly directed cooling fluid passages starting from the central cooling fluid supply passage are provided within the cap body.

Since the cap body is cooled from the inside by a plurality of cooling fluid passages, a lower cooling fluid consumption or a shorter cooling time results overall, which is in particular of advantage when a heatable cap is provided or the connection element is primarily heated via the cap coming into contact therewith. In addition, the noise development on the cooling is considerably reduced by the apparatus in accordance with the invention.

To achieve a cooling effect which is as good as possible, the cooling fluid passages provided within the cap body are arranged as closely as possible to the contact surface of the cap body to the connection element.

In the simplest case, only two cooling fluid passages can be provided in the cap body. Expediently, however, more than two, in particular more than four, and preferably more than six, such cooling fluid channels can also be provided in the cap body.

In accordance with a preferred practical embodiment of the apparatus in accordance with the invention, two to ten respective at least generally radially outwardly directed cooling fluid passages are provided within the cap body.

The at least generally radially outwardly directed cooling fluid passages can in particular be distributed evenly in the peripheral direction, i.e. can be arranged so that the angular intervals between the respective adjacent cooling fluid passages are at least substantially of equal size.

In specific cases, it can, however, be of advantage if the at least generally radially outwardly directed cooling fluid passages are distributed unevenly in the peripheral direction, i.e. the angular intervals between the respective adjacent cooling fluid passages are at least partly different.

In this respect, the cooling fluid passage density can advantageously be higher in a defined region, in particular in a region of relatively larger material accumulation of the cap body than in the remaining cap body. This is, for example, of advantage when the cap body has a contact surface which faces the connection element due to the rivet head shape and which is no longer orthogonal, but inclined with respect to the cap shaft extending in the axial direction. A higher cooling fluid passage density can then be provided in the region of the thereby resulting material accumulation to increase the cooling effect in this region.

It is in particular of advantage if the angular intervals between the respective adjacent cooling fluid passages are smaller in the region of higher cooling passage density than in the remaining cap body.

In particular in the case that the contact surface of the cap body is no longer orthogonal, but rather inclined relative to the shaft extending in the axial direction due to the rivet head shape, it can also be of advantage if the cooling fluid passages each at least partly form an angle other than 90° with the axis of the cap shaft. In this respect, the cooling fluid passages are again preferably arranged as closely as possible to the rivet contact surface of the cap body which can be brought into contact with the rivet head to be formed to achieve a cooling effect which is as good as possible.

In accordance with a preferred embodiment of the apparatus in accordance with the invention, the cooling fluid passages initially have at least partly, starting from the central cooling fluid supply passage, a relatively smaller inner cross-sectional surface and subsequently a relatively larger inner cross-sectional surface, whereby the cooling effect is further increased. An expansion of the cooling fluid thus occurs in the region of the transition from a respective smaller inner cross-section to a relatively larger inner cross-section, which is accompanied by an additional cooling. The so-called Joule-Thomson effect is therefore utilized here.

This Joule-Thomson effect is also utilized in a further advantageous embodiment in accordance with which a constriction opening into the cooling fluid passages is provided in the region of the end of the central cooling fluid supply passage adjacent to the cooling fluid passages to effect an expansion of the cooling medium subsequent to said constriction.

It is of particular advantage in this respect if a replaceable insert having the constriction can be introduced into the end of the central cooling fluid supply passage adjacent to the cooling fluid passages. In this respect, the end of the cooling fluid supply passage adjacent to the cooling fluid passages can advantageously be provided with an internal thread into which the replaceable insert provided with an external thread can be screwed.

The insert expediently has a section with a relatively larger inner cross-sectional surface which is adjoined by an end section with the constriction having an inner cross-sectional surface relatively smaller in comparison therewith.

In accordance with a preferred practical embodiment, the insert can be selected from a plurality of inserts having constrictions of different inner cross-sectional surfaces. The cooling effect can be ideally adapted in a very simple manner to different cap geometries by the provision of a plurality of inserts having differently dimensioned constrictions and a corresponding selection of a respective insert.

The shaft of the cap can preferably be inserted into a carrier tube which has a central cooling fluid supply bore in extension of the central cooling fluid supply passage of the cap.

In this respect, a generally radially outwardly leading cooling fluid connection bore can branch off from the central cooling fluid supply bore of the carrier tube and a cooling fluid connection line can, for example, in particular be connected to said cooling fluid connection bore via a corresponding connector piece.

The cap can be moved toward the rivet point in the heated state by a feed unit including, for example, a pneumatic cylinder via an adjustment element of said feed unit including a piston rod, for example. As soon as the material beneath the rivet cap softens and the rivet head has formed, the associated heat source can be decoupled or switched off, after which the supply of the cooling fluid starts.

In accordance with a further advantageous embodiment, the carrier tube is connected to an adjustment element of a feed unit having a central cooling fluid supply bore, with the cooling fluid being able to be supplied to the cap in this case via the cooling fluid supply bore of the adjustment element and the cooling fluid supply bore of the carrier tube.

In accordance with a second alternative of the invention, the above object is satisfied in that the cap is manufactured at least partly from porous, air-permeable material, in particular ceramic material, and in that the shaft of the cap is provided with a central cooling fluid supply bore preferably reaching up to and into the cap body.

In this respect, at least the cap body is manufactured from such a porous, air-permeable material, in particular ceramic material. This preferably also applies to the cap shaft, however.

The cooling fluid supplied via the central cooling fluid bore thus flows outwardly via a plurality of small passages through the cap body and preferably also the cap shaft, whereby the cap is cooled uniformly and effectively.

In this case, the shaft of the cap is also again advantageously inserted into a carrier tube which has a central cooling fluid supply bore in extension of the central cooling fluid supply bore of the cap.

It is again also of advantage in this respect if a generally radially outwardly leading cooling fluid connection bore branches off from the central cooling fluid supply bore of the carrier tube and a cooling fluid connection line can in particular be connected to it.

In accordance with an alternative expedient embodiment, the carrier tube can also again be connected to an adjustment element of a feed unit having a central cooling fluid supply bore, with the cooling fluid in this case again being able to be supplied to the cap via the cooling fluid supply bore of the adjustment element and the cooling supply bore of the carrier tube.

As already mentioned, the cap can in particular be a heatable cap. The apparatus can therefore in particular be made so that the connection element can primarily be heated via the heated cap coming into contact therewith.

Ceramic heating elements as such are already known. It has, however, been found that they can only be cooled very slowly and under high air consumption by means of a conventional air cooling from the outside. With the cooling in accordance with the invention, short cooling times and a relatively low cooling fluid consumption as well as lower noise on cooling can also be achieved without problem on the use of such ceramic heating elements.

The invention also relates to an apparatus for the connection of articles or at least to a connection element plasticizable by heat, the apparatus having a heatable cap, which is movable toward and away from the connection element and which has a shaft, for the forming of a rivet head at the connection element and having means for the direct heating of the cap which is characterized in that the means for the direct heating of the cap include at least one ceramic heating element.

Such an apparatus in accordance with the invention having a ceramic heating element is now preferably combined with a cooling in accordance with the invention, with this apparatus having a ceramic heating element defined in claim 21, however, generally also being conceivable without such a cooling in accordance with the invention.

The ceramic heating element is preferably in direct contact with the cap body.

In this respect, the ceramic heating element is preferably fixedly connected to the cap.

It is in particular of advantage if the ceramic heating element is pressed toward the cap body.

A preferred practical embodiment is characterized in that the ceramic heating element has an annular design and is attached to the cap shaft in direct contact with the cap body.

It is in particular of advantage in this respect if the ceramic heating element is clamped between the cap body and a carrier tube, with the cap shaft having an external thread and being screwed into an internal thread of the carrier tube. The ceramic heating element is in this respect therefore clamped between the cap body and the carrier tube by screwing the cap shaft into the internal thread of the carrier tube.

The ceramic heating element can be manufactured at least partly from at least one of the following compounds: aluminum oxide (Al₂O₃), zirconium dioxide (ZrO₂), silicon nitride (Si₃N₄) and aluminum nitride (AlN).

Means for the detection and/or monitoring of the temperature are advantageously also associated with the ceramic heating element, with them in particular being able to include at least one thermal sensor.

The invention will be explained in more detail in the following with reference to embodiments and to the drawing; in which are shown:

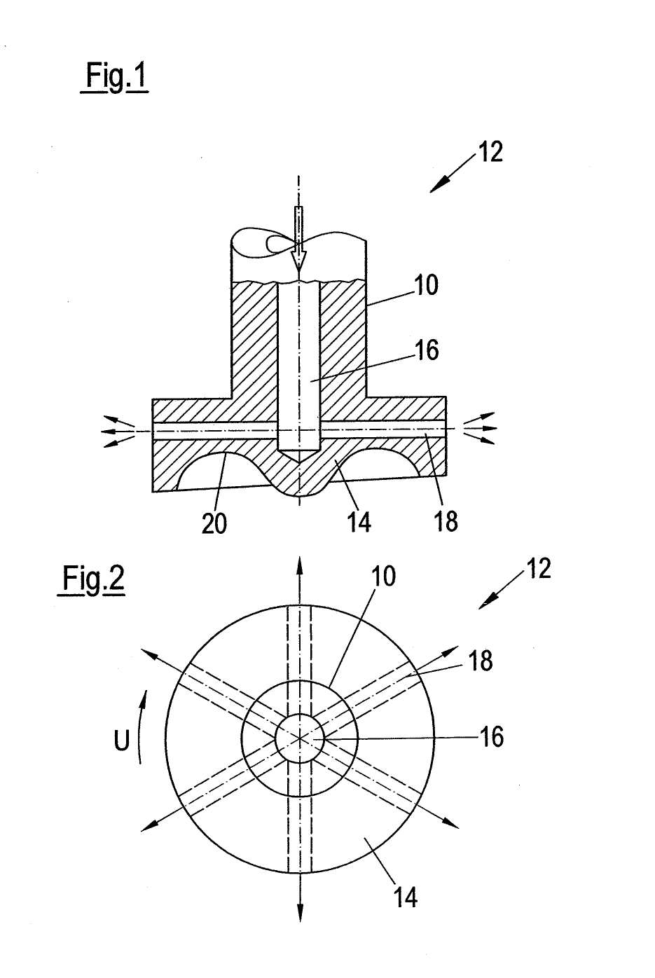

FIG. 1 a schematic, partly sectional representation of an exemplary embodiment of a cap with evenly distributed cooling fluid passages;

FIG. 2 a schematic plan view of the cap in accordance with FIG. 1;

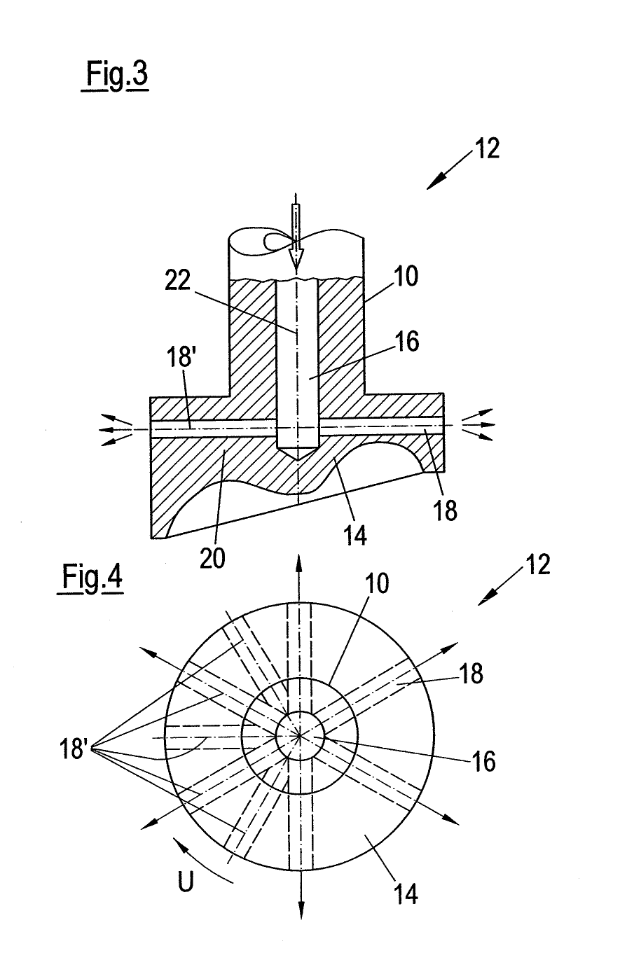

FIG. 3 a schematic, partly sectional representation of a further exemplary embodiment of a cap with unevenly distributed cooling fluid passages;

FIG. 4 a schematic plan view of the cap in accordance with FIG. 3;

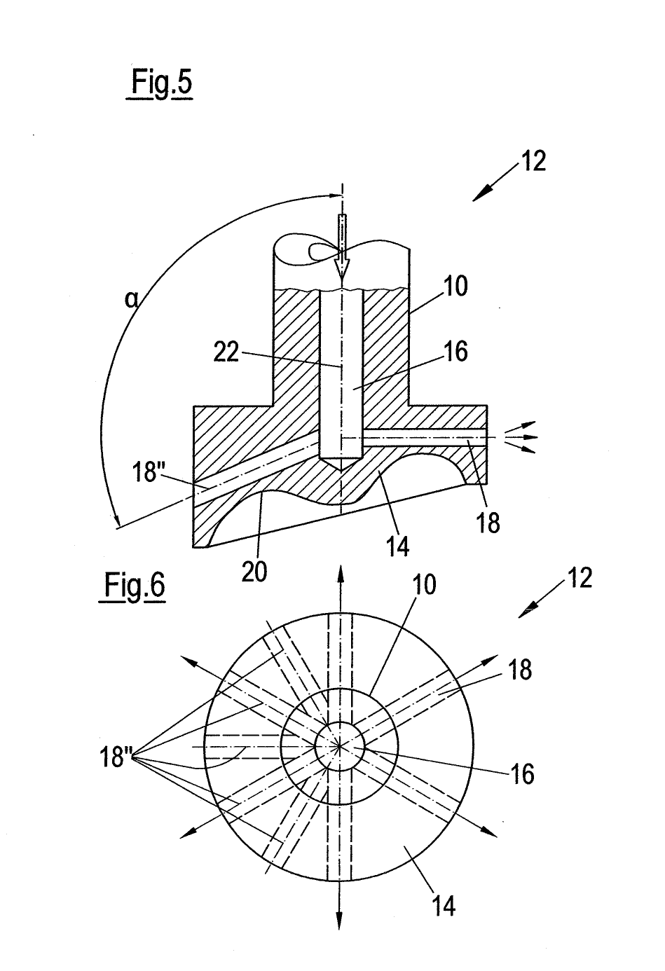

FIG. 5 a schematic, partly sectional representation of a further exemplary embodiment of a cap whose cooling fluid passages at least partly form an angle other than 90° with the axis of the cap shaft;

FIG. 6 a schematic plan view of the cap in accordance with FIG. 5;

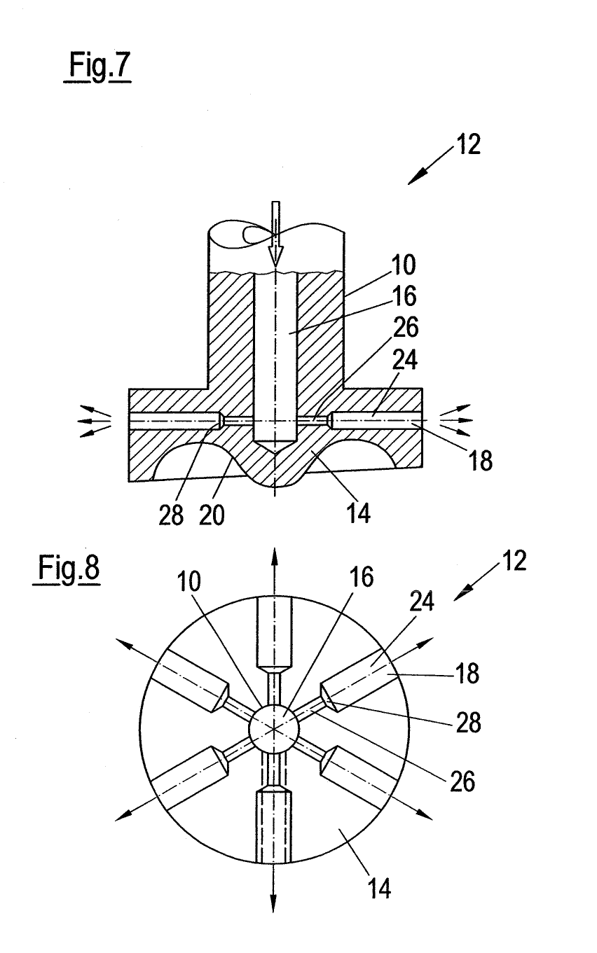

FIG. 7 a schematic, partly sectional representation of a further exemplary embodiment of a cap whose cooling fluid passages, starting from the central cooling fluid supply passage, each first have a relatively smaller inner cross-sectional surface and subsequently a relatively larger inner cross-sectional surface.

FIG. 8 a schematic plan view of the cap in accordance with FIG. 7;

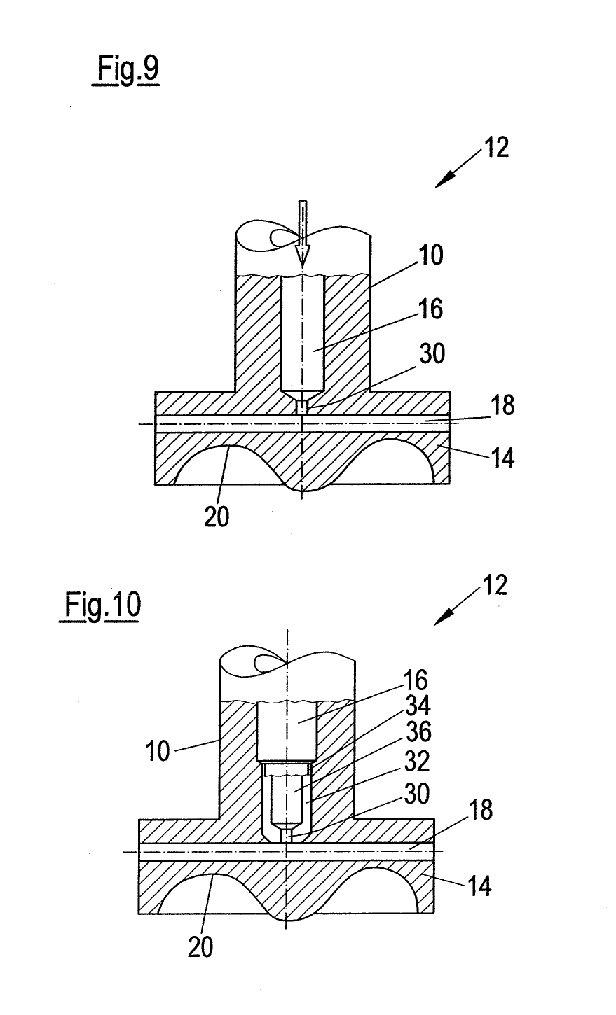

FIG. 9 a schematic, partly sectional representation of a further exemplary embodiment of a cap in which a constriction opening into the cooling fluid passages is provided in the region of the end of the central cooling fluid supply passage adjacent to the cooling fluid passages;

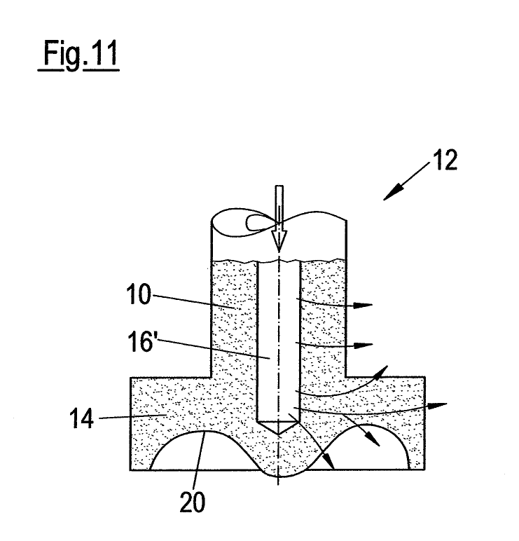

FIG. 10 a schematic, partly sectional representation of a further having the constriction can be introduced into the end of the central cooling fluid supply passage adjacent to the cooling fluid passages;

FIG. 11 a schematic, partly sectional representation of a further exemplary embodiment of a cap which is manufactured at least in part from porous, air-permeable material, in particular ceramic material;

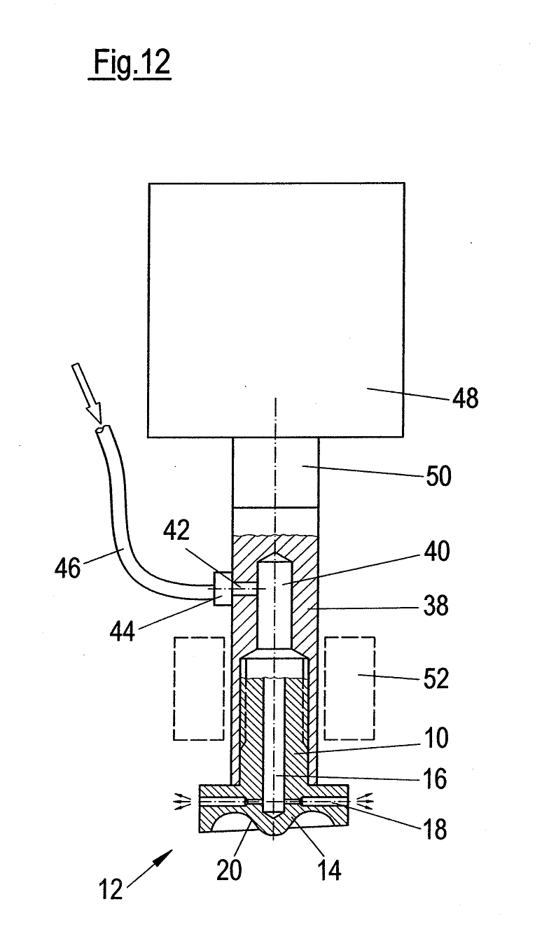

FIG. 12 a schematic, partly sectional representation of an exemplary embodiment of the apparatus for the connection of articles in which a shaft of a cap can be inserted into a carrier tube having a cooling fluid connection bore;

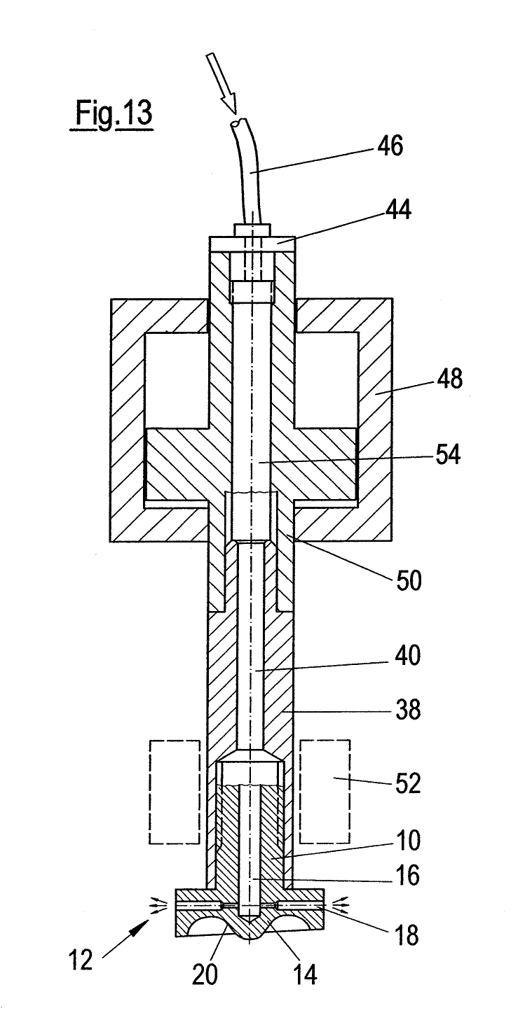

FIG. 13 a schematic, partly sectional representation of an exemplary embodiment of the apparatus in which a shaft of a cap can be inserted into a carrier tube which is connected to an adjustment element of a feed unit having a central cooling fluid supply bore;

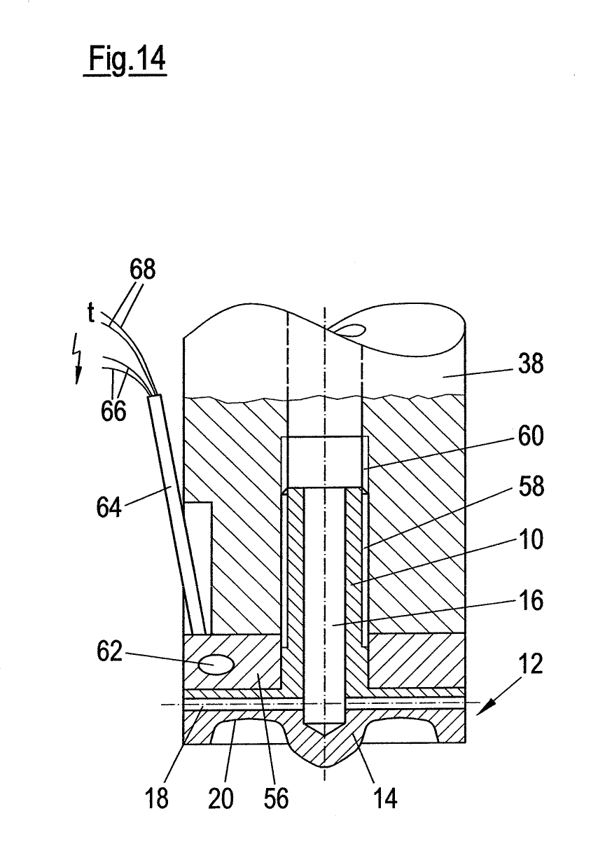

FIG. 14 a schematic part representation of an exemplary embodiment of the apparatus for the connection of articles having a ceramic heating element for the direct heating of the cap; and

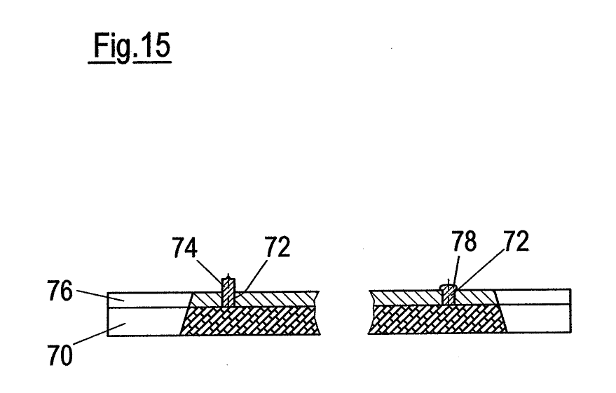

FIG. 15 an exemplary representation of the so-called rivet peg welding principle according to which the apparatus in accordance with the invention can operate.

An apparatus for the connection of articles via at least one connection element plasticizable by heat includes a cap 12, in particular a heatable cap, which is movable toward and away from the connection element and which has a shaft 10, for the forming of a rivet head at the connection element and includes means for the cooling of the cap 12 by means of a cooling fluid, in particular air (cf. FIGS. 1 to 14). In FIGS. 1 to 10, different embodiments of the cap 12 of such an apparatus are shown in which in each case the shaft 10 of the cap 12 has a central cooling fluid supply passage 16 preferably reaching up to and into the cap body 14 and respective at least generally radially outwardly directed cooling fluid passages 18, 18′ 18″ starting from the central cooling fluid supply passage 16 are provided within the cap body 14.

In this respect, for example, two to ten respective at least generally radially outwardly directed cooling fluid passages 18, 18′, 18″ can be provided within the cap body 14. Generally, however, more than ten cooling fluid passages are also conceivable.

FIG. 1 shows in a schematic, partly sectional representation an exemplary embodiment of a cap 12 in which a plurality of radially outwardly directed cooling fluid passages 18 are distributed evenly in the peripheral direction U (cf. also FIG. 2), i.e. the angular intervals between the respective adjacent cooling fluid channels 18 are of equal size. The cooling fluid channels 18 in the present case extend radially outwardly in star shape starting from the central cooling fluid supply passage 16.

The heated cooling fluid, in particular air, escapes outwardly via the cooling fluid passages 18.

To achieve a cooling effect which is as good as possible, the radial cooling fluid passages 18 can be arranged as closely as possible to the rivet contact surface 20 of the cap body 14 which can be brought into contact with the rivet head to be formed.

In FIG. 2, the cap 12 in accordance with FIG. 1 is shown in a schematic plan view.

FIG. 3 shows in a schematic partly sectional representation a further exemplary embodiment of a cap 12 in which the radially outwardly directed cooling fluid passages 18, 18′ are distributed unevenly in the peripheral direction U (cf. in particular also FIG. 4). In the present case, the angular intervals between the respective adjacent cooling fluid passages 18, 18′ are therefore different at least in part.

In this respect, the cooling fluid passage density can be higher in a defined region, in particular in a region of relatively larger material accumulation of the cap body 14, than in the remaining cap body. In the present case, for example, the angular intervals between the respective adjacent cooling fluid passages 18′ are for this purpose smaller in the region of higher cooling fluid passage density than in the remaining cap body.

In the present embodiment, the cap head 14 has a rivet contact surface 20 not orthogonal to the shaft 10 or to its axis 22 due to the rivet head shape, whereby the cap body 14 is given an asymmetrical material distribution. The cooling channels 18, 18′ are now arranged so that the region of the material accumulation is supplied with more cooling fluid. For this purpose, in the present case, a higher number of radial cooling fluid passages 18′ is provided in this region, whereby overall an arrangement of the cooling fluid passages 18, 18′ results which is no longer symmetrical to one another.

In FIG. 4, the cap 12 in accordance with FIG. 3 is shown in a schematic plan view.

FIG. 5 shows in a schematic, partly sectional representation a further exemplary embodiment of a cap 12 in which the cooling fluid passages 18, 18′ each form an angle α other than 90° at least partly with the axis 22 of the cap shaft 10. In this respect, the cooling fluid passages 18, 18″ are preferably again arranged as closely as possible to the rivet contact surface 20 of the cap body 14 which can be brought into contact with the rivet head to be formed.

FIG. 6 shows the cap 12 in accordance with FIG. 5 in a schematic plan view.

In the present case, the cap body 14 has a rivet contact surface 20 which is not orthogonal to the shaft 10 due to the rivet head shape, whereby again at least one region arises in which exactly radially extending cooling fluid passages would no longer extend in direct proximity to the rivet contact surface 20. Provision is accordingly made in the present embodiment to arrange the respective cooling fluid passages 18″ so that they each form an angle other than 90° with the axis 22 of the cap shaft 10, with this angle preferably being selected so that the respective cooling fluid passages 18″ are again arranged as closely as possible to the rivet contact surface 20.

FIG. 7 shows in a schematic, partly sectional representation a further exemplary embodiment of a cap 12 in which the cooling fluid passages 18, starting from the central cooling fluid supply passage 16, initially have a relatively smaller inner cross-sectional surface and subsequently a relatively larger inner cross-sectional surface.

FIG. 8 shows the cap 12 in accordance with FIG. 7 in a schematic plan view.

In the present case, the radial cooling fluid passages 18 are therefore made such that they each have a radially outer passage section 24 of larger cross-section and a radially inner passage section 26 of smaller cross-section, whereby the cooling effect is increased once a cross-sectional extension results in the region 28 of the transition between the two passage sections 24, 26 which brings along an expansion of the cooling fluid, whereby the air is additionally cooled due to the Joule-Thomson effect.

FIG. 9 shows in a schematic, partly sectional representation a further exemplary embodiment of the cap 12 in which a constriction 30 opening into the cooling fluid passages 18 is provided in the region of the end of the central cooling fluid supply passage 16 adjacent to the cooling fluid passages 18 to effect an expansion of the cooling medium subsequent to said constriction. In this case, too, the Joule-Thomson effect is therefore again utilized to increase the cooling effect.

FIG. 10 shows in a schematic, partly sectional representation a further exemplary embodiment of the cap 12. In the present case, a replaceable insert 32 having the constriction 30 can be introduced into the end of the central cooling fluid supply passage 16 adjacent to the cooling fluid passages 18.

In this respect, the end of the central cooling fluid supply passage 16 adjacent to the cooling fluid passages 18 can be provided with an internal thread 34 into which the replaceable insert 32 provided with an external thread can be screwed.

As can be recognized with reference to FIG. 10, the insert 32 can in particular have a section 36 with a relatively larger inner cross-sectional surface which is adjoined by an end section with the restricted surface 30 having an inner cross-sectional surface relatively smaller in comparison therewith. It is again achieved by the constriction 30 that the supplied cooling fluid is expanded and cooled when it enters into the cooling fluid passages 18 here in particular radial again.

The replaceable insert 32 can advantageously be selected from a plurality of inserts with constrictions of different inner cross-sectional surfaces. The cooling effect can be ideally adapted to different cap geometries in a simple manner by a corresponding selection from such a plurality of inserts with constrictions of different inner cross-sectional surfaces.

FIG. 11 shows in a schematic, partly sectional representation a further exemplary embodiment of a cap 12 of a corresponding apparatus for the connection of articles via at least one connection element plasticizable by heat.

In the present case, the cap 12 is manufactured at least partly from porous, air-permeable material, in particular ceramic material. The shaft 10 of the cap 12 is provided with a central cooling fluid supply bore 16′ preferably again reaching up to and into the cap body 14. In this respect, at least the cap body 14, or as in the embodiment shown in FIG. 11 additionally also the cap shaft 10, can be manufactured from a corresponding porous, air-permeable material, in particular ceramic material.

The cooling fluid, in particular air, supplied via the central cooling supply bore 16′ therefore flows outwardly through a plurality of small passages through the cap body 14 and the cap shaft 10, whereby the cap 12 is cooled evenly and effectively.

FIG. 12 shows in a schematic, partly schematic representation an exemplary embodiment of the apparatus for the connection of articles via at least one connection element plasticizable by heat in which a shaft 10 of a cap 12 can be inserted into a carrier tube or spacer tube 38 which has a central cooling fluid supply bore 40 in extension of the central cooling fluid supply passage 16 or cooling fluid supply bore 16′ (cf. also FIG. 11) of the cap 12. The cap 12 can in particular be a cap of the kind shown in FIGS. 1 to 10 or also a cap of the kind shown in FIG. 11.

In the present exemplary embodiment, a generally radially outwardly leading cooling fluid connection bore 42 branches off from the central cooling fluid supply bore 40 of the carrier tube 38 and a cooling fluid connection line 45 can, for example, be connected to said cooling fluid connection bore via a connector piece 44.

The cap 12 can therefore in particular be installed into a heat contact unit. In this respect, the shaft 10 of the cap 12 can be screwed into the carrier tube 38.

For the riveting, the cap 12 is moved toward the rivet point in the heated state by a feed unit 48 which can, for example, include a pneumatic cylinder via the adjustment element 50 of said feed unit including a piston rod, for example. As soon as the material beneath the cap has softened and the rivet head has formed, an associated heat source 52 can, for example, be decoupled and the introduction of cooling fluid can be initiated.

FIG. 13 shows in a schematic, partly sectional representation an exemplary embodiment of the apparatus for the connection of articles via at least one connection element plasticizable by heat in which the carrier tube 38 is connected to an adjustment element 50 of a feed unit having a central cooling fluid supply bore 45 and the cooling fluid can be supplied to the cap 12 via the cooling fluid supply bore 54 of the adjustment element 50 and the central cooling fluid supply bore 40 of the carrier tube 38. The feed unit 48 can, for example, again include a pneumatic cylinder or the like.

In this respect, the adjustment element 50, which can include a piston rod, for example, is therefore provided with a central cooling fluid supply bore 54 so that the cooling fluid, which is supplied, for example, via a cooling fluid connection line 46 connected to the adjustment element 50 via a connector piece 44, is supplied into the cap body 14 through the central cooling fluid supply bore 54 of the adjustment central element 50, the central cooling fluid supply bore 40 of the carrier tube 38 and the central cooling fluid supply passage 16 or cooling fluid supply bore 16′ (cf. also FIG. 11) of the cap 12.

The cap 12 can again also be a cap of the kind shown in FIGS. 1 to 10 or a cap of the kind shown in FIG. 11 in this case.

FIG. 14 shows in a schematic part representation an exemplary embodiment of an apparatus for the connection of articles via at least one connection element plasticizable by heat which apparatus is turn includes a cap 12, in particular a heatable cap, which is movable toward and away from the connection element and which has a shaft 10, for forming a rivet head at the connection element and includes means for the cooling of the cap 12 by means of a cooling fluid, in particular air.

In the present case, means for the direct heating of the heatable cap 12 are provided which include a ceramic heating element 56.

In this respect, the ceramic heating element 56 can in particular be in direct contact with the cap body 14.

The ceramic heating element 56 is expediently fixedly connected to the cap 12.

The ceramic heating element 56 can in particular be pressed toward the cap body 14.

The ceramic heating element 56 preferably comprises an annular design. It can be attached to the cap shaft 10 in direct contact with the cap body 14.

As can be recognized with reference to FIG. 14, the ceramic heating element 56 can be clamped between the cap body 14 and a carrier tube 38, with the cap shaft 10 expediently having an external thread 58 and being screwed into an internal thread 60 of the carrier tube 38. The ceramic heating element 56 is in this respect clamped between the cap body 14 and the carrier tube 38 by screwing the cap shaft 10 into the internal thread 60 of the carrier tube 38. Means for the detection and/or monitoring of the temperature can in particular also be associated with the ceramic heating element 56, with them in particular being able to include at least one thermal sensor. In FIG. 14, such a thermal sensor 62 associated with the ceramic element 56 and an electric connector 64 can be recognized which includes lines 66 for the power supply of the thermal sensor 62 and lines 68 for the evaluation of the measured signals of the thermal sensor 62.

FIG. 15 shows an exemplary representation of the so-called rivet peg welding principle according to which the apparatus in accordance with the invention can operate. In accordance with this, a projection, the so-called rivet peg 74, formed at a connection element 72 attached to a first article 70 is first pushed through an opening of a second article 76 (cf. left hand side of FIG. 15) and the connection element 72 is then provided with a shaped rivet head 78 at the free end of the rivet peg 74 (cf. right hand side of FIG. 15). In this respect, the connection element can also comprise a separate component which is pushed through both articles and has an already applied head at one end.

### REFERENCE NUMERAL LIST

10 shaft
12 cap
14 cap body
16 central cooling fluid supply passage
16′ central cooling fluid supply bore
18 cooling fluid passage
18 cooling fluid passage
18 cooling fluid passage
20 rivet contact surface
22 shaft axis
24 radially outer passage section
26 radially inner passage section
28 transition region
30 constriction
32 insert
34 internal thread
36 section
38 carrier tube
40 central cooling fluid supply bore
42 cooling fluid connection bore
44 connector piece
46 cooling fluid connection line
48 feed unit
50 adjustment element
52 heat source
54 cooling fluid supply bore
56 ceramic heating element
58 external thread
60 internal thread
62 thermal sensor
64 electric connection
66 lines for the power supply of the thermal sensor 62
68 lines for the evaluation of the measured signals of the thermal sensor 62
70 first article
72 connection element
74 rivet peg
76 second article
78 rivet head
U peripheral direction
α cooling fluid passage 18, 18′ and 18″

1. An apparatus for the connection of articles via at least one connection element plasticizable by heat, the apparatus having a cap (12), in particular a heatable cap, which is movable toward and away from the connection element and which has a shaft (10), for the forming of a rivet head at the connection element and having means (12) for the cooling of the cap (12) by means of a cooling fluid, in particular air,
characterized in that
the shaft (10) of the cap (12) has a central cooling fluid supply passage (16) preferably reaching up to and into the cap body (14) and a plurality of respective at least generally radially outwardly directed cooling fluid passages (18, 18′, 18″) starting from the central cooling fluid supply passage (16) are provided within the cap body (14).

2. An apparatus in accordance with claim 1, characterized in that two to ten respective at least generally radially outwardly directed cooling fluid passages (18, 18′, 18″) are provided within the cap body.

3. An apparatus in accordance with claim 1, characterized in that the at least generally radially outwardly directed cooling fluid passages (18) are evenly distributed in the peripheral direction (U), i.e. the angular intervals (18) between the respective adjacent cooling fluid passages are of equal size.

4. An apparatus in accordance with claim 1, characterized in that the at least generally radially outwardly directed cooling fluid passages (18, 18′) are distributed unevenly in the peripheral direction (U), i.e. the angular intervals between the respective adjacent cooling fluid channels (18, 18′) are different at least in part.

5. An apparatus in accordance with claim 4, characterized in that the cooling fluid passage density is higher in a defined region, in particular in a region of relatively larger material accumulation of the cap body (14), than in the remaining cap body.

6. An apparatus in accordance with claim 5, characterized in that the angular intervals between the respective adjacent cooling fluid passages (18′) are smaller in the region of higher cooling fluid passage density than in the remaining cap body.

7. An apparatus in accordance with claim 1, characterized in that the cooling fluid passages (18, 18″) each at least partly form an angle (α) other than 90° with the axis (22) of the cap shaft (10), with the cooling fluid passages (18, 18″) preferably being arranged as closely as possible to the rivet contact surface (20) of the cap body (14) which can be brought into contact with the rivet head to be formed.

8. An apparatus in accordance with claim 1, characterized in that the cooling fluid passages (18) initially have at least partly, starting from the central cooling fluid supply passage (16), a relatively smaller inner cross-sectional surface and subsequently a relatively larger inner cross-sectional surface.

9. An apparatus in accordance with claim 1, characterized in that a constriction (30) opening into the cooling fluid passages (18) is provided in the region of the end of the central cooling fluid supply passage (16) adjacent to the cooling fluid passages (18) to effect an expansion of the cooling medium subsequent to said constriction.

10. An apparatus in accordance with claim 9, characterized in that a replaceable insert (32) having the constriction (30) can be introduced into the end of the central cooling fluid supply passage (16) adjacent to the cooling fluid passages (18).

11. An apparatus in accordance with claim 10, characterized in that the end of the central cooling fluid supply passage (16) adjacent to the cooling fluid passages (18) is provided with an internal thread (34) into which the replaceable insert (32) provided with an external thread can be screwed.

12. An apparatus in accordance with claim 10, characterized in that the insert (32) has a section (36) with a relatively larger inner cross-sectional surface which is adjoined by an end section with the constriction (30) having an inner cross-sectional surface relatively smaller in comparison therewith.

13. An apparatus in accordance with claim 11, characterized in that the replaceable insert (32) can be selected from a plurality of inserts with constrictions (30) of different inner cross-sectional surfaces.

14. An apparatus in accordance with claim 1, characterized in that the shaft (10) of the cap (12) can be inserted into a carrier tube (38) which has a central cooling fluid supply bore (40) in extension of the central cooling fluid passage (16) of the cap.

15. An apparatus in accordance with claim 14, characterized in that a generally radially outwardly leading cooling fluid connection bore (42) to which in particular a cooling fluid connection line (46) can be connected branches off from the central cooling fluid supply bore (40) of the carrier tube (38).

16. An apparatus in accordance with claim 14, characterized in that the carrier tube (38) is connected to an adjustment element (50) of a feed unit (48) having a central cooling fluid supply bore (54); and in that the cooling fluid can be supplied to the cap (12) via the cooling fluid supply bore (54) of the adjustment element (50) and the cooling fluid supply bore (40) of the carrier tube (38).

17. An apparatus for the connection of articles via at least one connection element plasticizable by heat, the apparatus having a cap (12), in particular a heatable cap, which is movable toward and away from the connection element and which has a shaft (10), for the forming of a rivet head at the connection element and having means for the cooling of the cap (12) by means of a cooling fluid, in particular air,
characterized in that
the cap (12) is manufactured at least partly from porous, air-permeable material, in particular ceramic material; and in that the shaft (10) of the cap (12) is provided with a central cooling fluid bore (16′) preferably reaching up to and into the cap body (14).

18. An apparatus in accordance with claim 17, characterized in that the shaft (10) of the cap (12) can be inserted into a carrier tube (38) which has a central cooling fluid supply bore (40) in extension of the central cooling fluid supply bore (16′) of the cap (12).

19. An apparatus in accordance with claim 18, characterized in that a generally radially outwardly leading cooling fluid connection bore (42) to which in particular a cooling fluid connection line (46) can be connected branches off from the central cooling fluid supply bore (40) of the carrier tube (38).

20. An apparatus in accordance with claim 18, characterized in that the carrier tube (38) is connected to an adjustment element (50) of a feed unit (48) having a central cooling fluid supply bore (54); and in that the cooling fluid can be supplied to be cap (12) via the cooling fluid supply bore (54) of the adjustment element (50) and the cooling fluid supply bore (40) of the carrier tube (38).

21. An apparatus for the connection of articles via at least one connection element plasticizable by heat, the apparatus having a heatable cap (12), which is movable toward and away from the connection element and which has a shaft (10), for the forming of a rivet head at the connection element and having means for the direct heating of the cap (12),
characterized in that
the means for the direct heating of the cap (12) include at least one ceramic heating element (56).

22. An apparatus in accordance with claim 21, characterized in that the ceramic heating element (56) is in direct contact with the cap body (14).

23. An apparatus in accordance with claim 22, characterized in that the ceramic heating element (56) is fixedly connected to the cap (12).

24. An apparatus in accordance with claim 21, characterized in that the ceramic heating element (56) is pressed toward the cap body (14).

25. An apparatus in accordance with claim 21, characterized in that the ceramic heating element (56) has an annular design and is attached to the cap shaft (10) in direct contact with the cap body (14).

26. An apparatus in accordance with claim 25, characterized in that the ceramic heating element (56) is clamped between the cap body (14) and a carrier tube (38), with the cap shaft (10) having an external thread (58) and being screwed into an internal thread (60) of the carrier tube (38).

27. An apparatus in accordance with claim 21, characterized in that means for the temperature detection and/or temperature monitoring are associated with the ceramic heating element (56), with them preferably including at least one thermal sensor (62).
